(19) United States
(12) Patent Application Publication
(10) Pub. No.: US 2014/0107230 A1
(43) Pub. Date: Apr. 17, 2014

(54) Wetting Agent for Electrolytic Applications and Use Thereof

(71) Applicant: Anke GmbH & Co., KG, Essen (DE)

(72) Inventor: Carsten Mendus, Essen (DE)

(73) Assignee: Anke GmbH & Co. KG, Essen (DE)

(21) Appl. No.: 14/118,666

(22) PCT Filed: May 21, 2012
(86) PCT No.: PCT/EP2012/002151

§ 371 Date: Dec. 20, 2013

(30) Foreign Application Priority Data
May 19, 2011 (DE) 102011102052.0

(51) Int. Cl. B01F 17/00

(52) U.S. Cl. CPC B01F 17/0057
USPC 516/200

(57) ABSTRACT

The invention relates to a wetting agent and to its use. The wetting agent comprises a biodegradable surfactant which is present in a solution in water, and allows foam to be formed during the electroplating application. The stability of the foam formed allows retarded release of the hydrogen that is formed during the galvanic application. This wetting agent is stable to degradation and has no effect at all on the electroplating application. The wetting agent of the invention exhibits good biodegradability. The level of consumption of the wetting agent is comparable with using PFOS-containing wetting agents. The wetting agent provides a simple, eco-friendly and time cost-effective alternative to the known PFOS-free wetting agents, with the wetting agent of the invention exerting no effect on the outcome of the electroplating application, by virtue of reduced wetting agent consumption and by virtue of the chemically-inert properties of said wetting agent.

### FIELD OF THE INVENTION

The invention relates to a wetting agent for electrochemical applications and its use.

### TECHNOLOGICAL BACKGROUND

Electrochemical processes for surface coatings on objects have been known for a long time. Objects can be given special functional and/or decorative surface properties, e.g. hardness, corrosion resistance, metallic appearance, gloss, etc., by means of electrochemical processes.

Here, the metal is deposited by means of direct current on the object connected as cathode from an electrolysis bath which contains at least the metal to be deposited as salt in solution. In this case, the object to coated usually consists of a metallic material. If the substrate material is not electrically conductive, metallization of the surface is necessary. Electrolysis baths which contain, for example, nickel or chromium are usually employed in industrial applications in order to produce particularly hard mechanically resistant layers.

The application of chromium to objects is of particular industrial relevance, and this is carried out either for decorative purposes or as hardening coating on the objects in industrial applications. In the case of decorative applications, a bright and highly reflective chromium layer is particularly desired. In the case of industrial applications, the chromium layers applied should be low-wear, abrasion-stable, heat resistant and corrosion resistant. Such chromium-plated objects are, for example, pistons, cylinders, bushings or axle bearings.

Electrochemical chromium plating is usually carried out in electrolysis baths containing chromium(VI) salts and sulfuric acid using insoluble lead/antimony or lead/tin anodes. CrO₃ in particular is known as chromium(VI) salt for this purpose.

A substantial problem in electrochemical applications, for instance chromium-plating by means of chromium(VI) solutions, is gas evolution, in particular of hydrogen, occurring as a result of the low efficiency of 15%-25%, and to a lesser extent also anodic oxygen evolution which leads to the formation of acidic, corrosive and sometimes also toxic spray mist. This gas evolution entrains, for example, a chromic acid mist which is a serious hazard to health and makes intensive extraction of gas above the surface of the electrolysis bath necessary.

To limit the occurrence of this chromic acid mist, surface-active substances which reduce the surface tension to form a foam blanket are used in chromium-plating baths. Such surface-active substances are also referred to as wetting agents.

Furthermore, there is the risk of an H₂/O₂ gas reaction in the case of excessive evolution of hydrogen. To ensure appropriate process safety, the hydrogen given off is extracted above the bath surface. To prevent a high concentration of hydrogen above the bath surface, retarded liberation of hydrogen is desirable.

Thus, U.S. Pat. No. 4,006,064 proposes using quaternary ammonium perfluoroalkanesulfonates as surface-active substance in chromium plating. The best known of these compounds is the chemically related PFOS (perfluorooctanesulfonic acid) which was, in particular, used in chromium plating. Previous wetting agents therefore usually contained PFOS (perfluorooctanesulfonate) which is the anion of the salt of perfluorooctanesulfonic acid and belongs to the perfluorinated surfactants. This is usually marketed as sodium perfluorooctanesulfonate or potassium perfluorooctanesulfonate. However, this perfluorinated surfactant has now been prohibited because of its carcinogenic properties.

Newer wetting agents for chromium plating processes are now usually PFOS-free and, according to legislators, are believed to be unharmful and biodegradable, but on prolonged use form a troublesome oil layer or lump formation in the chromium plating baths. In addition, unwanted corrosive attack by the degradation products of these substances has been reported. An example might be the use of fatty amine ethers, but the degradation products of these do not display the desired biodegradability.

In addition, increased consumption of these new wetting agents, which is generally a number of times that of the PFOS-containing wetting agents, has been reported. The use of phosphinic acids as surface-active substance in electrolysis baths is also known from DE 10 2006 025847 A1.

WO 2008/028932 A1 discloses long-chain alkylmonosulfonic acids, long-chain alkyldisulfonic acids, long-chain alkylpolysulfonic acids, salts of long-chain alkylmonosulfonic acids, salts of long-chain alkyldisulfonic acids and salts of long-chain alkyl-polysulfonic acids as constituents of fluorosurfactant-free, long-term-stable and biodegradable additives for chromic acid solutions which reduce the surface tension and thus improve the chromium deposition process.

It would therefore be highly desirable to use a wetting agent which ensures a consumption comparable to that in the case of the PFOS-containing wetting agents, is biodegradable and ensures that the electrochemical process and also the coated surface are not adversely affected.

### BRIEF DESCRIPTION OF THE INVENTION

It is therefore an object of the present invention to provide a wetting agent which overcomes the abovementioned disadvantages of the known wetting agents.

The object is achieved by a wetting agent as per the main claim. Advantageous embodiments are indicated in the dependent claims.

According to the invention, the wetting agent comprises a biodegradable surfactant as surface-active substance, wherein the surfactant is present in a concentration of from 1:1 to 1:10 dissolved in water.

For the purposes of the invention, a surfactant is a substance which reduces the surface tension of a liquid or the interfacial tension between two phases and makes possible or aids the formation of dispersions or acts as solubilizer. Surfactants generally consist of a hydrophobic (“water-repelling”) hydrocarbon radical and a hydrophilic (“water-loving”) moiety. The formation of foam is attributable to the properties of surfactants. The surfactant molecules form a film which consists of two layers and in which the hydrophobic ends of the surfactants form the two surfaces. The hydrophilic ends point inwards into the film.

For the purposes of the invention, wetting agents are substances or mixtures which bring about a reduction in the interfacial tension between a solid surface and a liquid.

In an advantageous embodiment, the concentration is from 1:2 to 1:6, preferably from 1:2 to 1:4.

According to one aspect of the invention, the surfactant is a nonionic surfactant. For the purposes of the invention, nonionic surfactants are surfactants which do not contain any dissociable functional groups and therefore do not separate into ions in water.

In an embodiment of the invention, the nonionic surfactant is a sugar surfactant.

For the purposes of the invention, sugar surfactants are nonionic surfactants in which carbohydrates form the hydrophilic part of the surfactant molecule. Fatty alcohols or fatty acids which, depending on the desired properties of the surfactants, are linked to the carbohydrates in chemically different ways function as hydrophobic component.

Sugar surfactants consist of a polar water-soluble head group and a nonpolar fat-soluble tail. They can be classified as ethers, esters, amines and amides according to the chemical bond between the sugar and the alkyl group. The HLB values of sugar surfactants depend on the degree of polymerization of the sugar as polar group and the number and length of the alkyl chains. Molecules having a plurality of alkyl chains are very hydrophobic. If the head group is a disaccharide, the surfactant is more hydrophilic.

The HLB (hydrophile-lipophile balance) indicates the mass ratio between the polar part and the nonpolar part. Surfactants having a low HLB have good fat-dissolving properties, while a high HLB brings about good wetting of hydrophilic surfaces. On the basis of different HLB values, it is possible to form stable emulsions, O/W through to W/O systems.

The use of sugar surfactants in the wetting agent according to the invention is advantageous since sugar surfactants display very good biodegradability.

In an advantageous embodiment of the invention, the sugar surfactant is selected from the group consisting of alkyl glycosides, alkyl polyglycosides, sorbitan fatty acid esters and polysorbates.

The alkyl glycosides used according to the invention are compounds which are known per se and whose preparation is described in numerous documents, e.g. in the US patents U.S. Pat. No. 3,547,828 A, U.S. Pat. No. 3,772,269 A, U.S. Pat. No. 3,839,318 A and the European patent applications EP 0 301 298 A, EP 0 357 969 A, EP 0 362 671 A and also the German first publication DE 39 27 919 A. Here, the reaction products of glycoses and alcohols, which are referred to as alkyl glycosides, can be prepared either by direct reaction with an excess of the alcohol and an acid as catalyst or by transacetalization using a lower alcohol as solvent and reactant. The alkyl glycosides used according to the invention are reaction products of the glycoses glucose, fructose, mannose, galactose, talose, gulose, allose, altrose, idose, arabinose, xylose, lyxose and ribose and alcohols having from 8 to 14 carbon atoms, with the glycoses being able to be linked glycosidically to one another.

Alkyl polyglycosides (APGs) consist entirely of the renewable raw materials sugar and fatty alcohols. They are biodegradable and have a low toxicity. Alkyl polyglycosides are hydrolysis-resistant and, owing to their HLB of >10, have a good dirt-dissolving and dirt-carrying capability. They foam strongly and do not have any skin-irritating constituents.

Known industrially important alkyl polyglucosides have a chain length of C₁₂-C₁₆ with an average degree of oligomerization of 1.4. These consist predominantly of monoglucosides having an additional but decreasing content of diglucosides, triglucosides and polyglucosides.

Even very small amounts of APGs influence both the surface tension and the interfacial tension in a lasting manner.

In terms of the wetting capability, there are characteristic differences between the APGs according to their chain length. The relatively long-chain APGs require significantly less time for complete wetting. The wetting capability is also dependent on the pH. The foaming capability of the APGs is also chain-length-dependent, with APGs having a chain length of C₁₂-C₁₆ displaying a particularly high intensity compared to, for example, fatty alcohol ethoxylates, especially in soft water.

The function and properties of the APG can thus advantageously be matched to requirements via the chain length of the alcohol and the degree of oligomerization.

In addition, APGs display synergistic effects when used together with other surfactants, e.g. anionic surfactants. This makes it possible to set a targeted degree of foam formation.

For the purposes of the present invention, the term sorbitan fatty acid esters refers to a group of four mono-fatty acid esters and one tri-fatty acid ester of sorbitol or of 1,4-sorbitol anhydride (sorbitan for short), with sorbitan being able to be formed from sorbitol by elimination of water.

The sorbitan fatty acid esters occur both in cyclic furanose (five-membered ring) and cyclic pyranose (six-membered ring) form. Since a plurality of OH groups are present in the sorbitol or sorbitan molecule, various isomers can be formed in the preparation.

Known representatives of sorbitan fatty acid esters are sorbitan monostearate, sorbitan tristearate, sorbitan monolaurate, sorbitan monooleate and sorbitan monopalmitate. For the purposes of the present invention, polysorbates are chemical compounds formed by etherification of sorbitan fatty acid esters with polyethylene glycol. They are interface-active and are used as wetting agents.

The various types of polysorbates differ in terms of the fatty acid, the average number of polyoxyethylene units in the molecule and the degree of esterification. The following polysorbates are known:

Polysorbate 20 (polyoxyethylene-(20)-sorbitan monolaurate) (trade name Tween® 20), polysorbate 21 (polyoxyethylene-(4)-sorbitan monolaurate), polysorbate 40 (polyoxyethylene-(20)-sorbitan monopalmitate), polysorbate 60 (polyoxyethylene-(20)-sorbitan monostearate), polysorbate 61 (polyoxyethylene-(4)-sorbitan monostearate), polysorbate 65 (polyoxyethylene-(20)-sorbitan tristearate), polysorbate 80 (polyoxyethylene-(20)-sorbitan monooleate), polysorbate 81 (polyoxyethylene-(5)-sorbitan monooleate), polysorbate 85 (polyoxyethylene-(20)-sorbitan trioleate), polysorbate 120 (polyoxyethylene-(20)-sorbitan monoisostearate).

According to another aspect of the invention, the surfactant is an anionic surfactant.

The term anionic surfactants refer to surfactants which have a negatively charged functional group, with an alkyl radical serving as nonpolar part and the polar, functional group being —COO⁻ (carboxylate), —SO₃⁻ (sulfonate) or —SO₄²⁻ (sulfate). In a further embodiment of the invention, the anionic surfactant is selected from the group consisting of alkylsulfates, secondary alkylsulfonates and secondary alkylbenzenesulfonates.

Sulfonic acids are organic sulfur compounds having the general structure R—SO₂—OH, where R is an organic radical. Salts and esters thereof having the general formula I are called sulfonates and in this case X can be an organic radical or a cation.

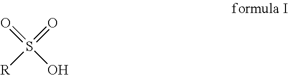

Sulfonic acids in which the group R of the general formula I is aliphatic are referred to as alkanesulfonic acids and salts and esters thereof as alkylsulfonates or as alkanesulfonates.

Alkylbenzenesulfonates (ABS) are a group of chemical compounds having the chemical formula CₙH₂ₙ₊₁—C₆H₄—SO₃⁻. The best-known representatives are linear alkylbenzene-sulfonates (LAS), but these are less commonly linear but rather secondary alkylbenzenesulfonates.

Some representatives of linear alkylbenzenesulfonic acids and alkylbenzenesulfonates are:

benzenesulfonic acid, dodecylbenzenesulfonic acid and sodium dodecylbenzenesulfonate (sodium salt), benzenesulfonic acid, C₁₀₋₁₃-alkyl derivatives, n-alkyl-benzenesulfonate, dodecylbenzenesulfonic acid, dodecylbenzenesulfonic acid, dodecyl benzenesulfonate.

Fatty alcohol sulfates (FAS), frequently also referred to as alkylsulfates, are sulfates of fatty alcohols having the general formula R—O—SO₃X. The fatty alcohols are obtained from fatty acids, frequently coconut oil, by reduction. The alcohols are reacted with sulfur trioxide or concentrated sulfuric acid to form the fatty alcohol sulfates. They are different from sulfonates which instead have an R—S bond.

Fatty alcohol sulfates are readily water-soluble, have little sensitivity to water hardness and are very readily biodegradable (even under anaerobic conditions). Owing to their good (even anaerobic) degradability, the renewable raw materials basis and relatively low-energy production, fatty alcohol sulfates represent a preferred embodiment of the invention. In addition, fatty alcohol sulfates are good foam formers.

A known representative of FASs is sodium dodecylpoly-(oxyethylene)sulfate (sodium lauryl ether sulfate, also sodium laureth sulfate, SLES), which is an ether sulfate and represents the ethoxylated form of sodium laurylsulfate.

Due to its additional foaming properties, SLES is used as foam former in many personal hygiene products, and also for the production of foamed concrete. SLES is used in toothpastes, shampoos, cosmetics, shower gels, liquid soaps, etc.

Apart from the anionic and nonionic surfactants mentioned, the use of amphoteric or cationic surfactants is also conceivable, but these have to be foam formers according to the invention and also display good biodegradability.

For the purposes of the present invention, amphoteric surfactants, which are also referred to as zwitterionic surfactants, are surfactants which have both a negatively charged functional group and a positively charged functional group. Like all surfactants, amphoteric surfactants are also made up of a polar part and a nonpolar part. The nonpolar part is an alkyl group and the polar part is usually a carboxylate group (R—COO⁻) together with a quaternary ammonium group (R₄N⁺).

The term cationic surfactants refers to surfactants which have a positively charged functional group. Like all surfactants, cationic surfactants are also made up of a polar part and a nonpolar part. Various alkyl groups serve as nonpolar part. The polar group is usually a quaternary ammonium unit.

Furthermore, it will be evident to a person skilled in the art that, depending on the desired degree of foam formation, a combination of a plurality of surfactants, also from various categories, is conceivable in the wetting agent of the invention.

In a further embodiment of the invention, the wetting agent additionally comprises a biocide, designed as pot preservative. For the purposes of the present invention, a pot preservative is, according to the chemicals laws of the EU and Switzerland, a product for protecting finished products (apart from foodstuffs and fodder) in containers against microbial damage for the purpose of prolonging their life. Addition of a pot preservative thus lastingly protects the wetting agent of the invention against microbial decomposition.

In a specific case of the above-described embodiment, the pot preservative is an isothiazolinone.

These isothiazolinones are heterocyclic organic compounds which occupy an important position among biocides. The parent substance of the group, isothiazolinone, is a compound which contains a sulfur atom, a nitrogen atom and a keto group in a five-membered cyclopentene ring (thiaazocyclopentenone).

Five isothiazolinone derivatives are used to a significant extent:

methylisothiazolinone (MIT, MI), chloromethylisothiazolinone (OMIT, CMI), benzisothiazolinone (BIT), octylisothiazolinone (OIT, OI), dichlorooctylisothiazolinone (DCOIT, DCOI).

According to the invention, preference is given to using methylisothiazolinone. However, the use of other biocides is also conceivable.

According to the invention, the wetting agent is used in electrochemical applications.

For the purposes of the invention, electrochemical applications are electrochemical techniques, of which known examples are electroforming, viz. the electrolytic production of metallic objects, and electroplating, viz. the production of metallic coatings.

A distinction is generally made between decorative and functional electrochemical techniques. The former serves predominantly for beautifying objects and has to possess particular minimum technical properties for this purpose. Examples of decorative electrochemical techniques are plastics electroplating, the chromium plating of tubular steel furniture and motorcycles and the gilding of jewelry and tableware.

Functional electrochemical techniques serve for corrosion protection, wear protection, catalysis or improving the electrical conductivity and reducing frictional forces. Examples are zinc-plating of screws, coating of machine parts with hard chromium, production of metallic, usually nickel- or platinum-containing, catalysts for the chemical industry or fuel cells and also gilding and silver-plating of electric contacts and the smoothing of, for example, medical appliances and materials. Electric contacts, known as pins, made of various copper materials are usually electroplated with tin. To prevent materials of the substrate diffusing through the tin layer, a nickel or copper barrier layer is generally applied before tin plating.

The wetting agent of the invention can be used in the following illustrative electrochemical applications:

anodic oxidation (in the case of aluminum also referred to as anodizing), tape electroplating, pickling, burning, bronzing, chromating, electrolytic plating, coloring of metal, pulsed electrodeposition, rack electroplating, plating of plastics, circuit board production, phosphating, pad electroplating, drum electroplating, metal facing, chromium plating and steel plating.

In a preferred embodiment, the wetting agent is employed in electrolysis baths containing the following electrolytes:

aluminum electrolytes, antimony electrolytes, lead electrolytes, bronze electrolytes, cadmium electrolytes, cobalt electrolytes, chromium electrolytes, iron electrolytes, gold electrolytes, indium electrolytes, copper electrolyte, manganese electrolytes, brass electrolytes, nickel electrolytes, nickel-iron electrolytes, palladium electrolytes, platinum electrolytes, rhenium electrolytes, rhodium electrolytes, ruthenium electrolytes, silver electrolytes, bismuth electrolytes, tungsten electrolytes, zinc electrolytes and tin electrolytes.

The wetting agent of the invention thus comprises at least one biodegradable surfactant which makes foam formation during the electrochemical use possible, with the foam formed having a stability which makes it possible to retard liberation of the hydrogen formed during the electrochemical use. The wetting agent is degradation-stable and has no influence on the electrochemical application, so that the workpieces processed by means of the electrochemical application are not adversely affected by use of the wetting agent of the invention. In addition, the wetting agent of the invention displays good biodegradability, so that separate disposal of the wetting agent after use becomes unnecessary. Furthermore, the consumption of the wetting agent is comparable to that when PFOS-containing wetting agents are used. As a result, the wetting agent of the invention provides a simple, environmentally friendly and at the same time inexpensive alternative to the known PFOS-free wetting agents, with the wetting agent of the invention having no influence on the result of the electrochemical application as a result of a reduced consumption and as a result of its inert chemical properties.

The abovementioned materials and the materials claimed and the materials described in the examples and to be used according to the invention are not subject to any particular exceptional conditions in terms of the selection of their materials and technical design, so that the selection criteria known in the field of use can be applied without restriction.

Further details, features and advantages of the subject matter of the invention are indicated in the dependent claims and also in the following description in which examples are presented by way of example. Individual features of the claims or of the embodiments can also be combined with other features of other claims and embodiments.

### DETAILED DESCRIPTION OF EXAMPLES

In a first example, the wetting agent comprises sodium dodecylpoly(oxyethylene)sulfate which is present in a concentration of 1:4 in an aqueous solution and methylisothiazolinone in a concentration of up to 0.01% by weight as is customary for pot preservatives.

When the wetting agent is used in a chromium plating bath, the concentration of the wetting agent in the case of a freshly made batch is 2 g/l in a conventional electrolytic bath solution for chromium-plating workpieces.

During the electrochemical deposition, the surface tension, which is determined by means of a tensiometer, is preferably <30 mN/m. If this is no longer the case during the process, it is necessary to add further amounts of the wetting agent of the invention. For this purpose, the wetting agent is introduced as a 1:1 dilution in aqueous solution by means of a metering device. This can advantageously be effected by means of a metering device, for instance a dosimeter, which is connected to the tensiometer via a regulating circuit and thus ensures addition as a function of the surface tension determined.

In a further example, the wetting agent comprises an alkyl polyglucoside of the general formula II having a chain length of C₁₂-C₁₆ and a degree of oligomerization of 1.4. An alkyl glucoside which is based on glucose and is a constituent of the alkyl polyglucoside is shown by way of example in the formula II, where n=12 to 16. In this example, the use of methylisothiazolinone is also conceivable, and this can be added in a concentration of up to 0.01% by weight.

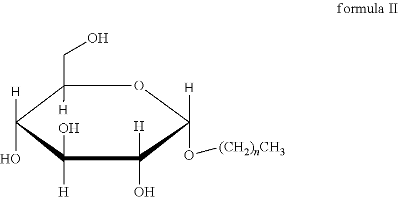

3.5 g/l of the wetting agent are added to the batch of electrolyte solution for chromium plating. The surface tension is then determined by means of a tensiometer. The desired surface tension should be <30 mN/m. To set the desired surface tension, a 1:1 dilution of the wetting agent in aqueous solution is introduced via a metering device into the electrolyte solution until the desired surface tension is achieved. Excessive foam formation before commencement of the electrochemical use is reduced by the subsequent setting of the desired surface tension.

During the electrochemical use, the surface tension continues to be monitored by means of a tensiometer, with wetting agent being introduced via a regulating circuit as a function of the surface tension.

In an alternative variant of the above-described example, the wetting agent comprises an alkyl polyglucoside of the general formula II having a chain length of n=8 to 12 and a degree of oligomerization of 1.2. In this case 4.5 g/l are added to the electrolyte batch and the surface tension is subsequently set as indicated above.

In a further example, the wetting agent is a polyoxyethylene-(20)-sorbitan monolaurate (polysorbate 20). In this case, 1 ml/l are added to the electrolyte batch and the surface tension is subsequently set as indicated above. The wetting agent can advantageously also contain methylisothiazolinone, with this being able to be added in a concentration of up to 0.01% by weight.

1. A wetting agent for electrochemical applications comprising a biodegradable surfactant selected from the group consisting of nonionic surfactants and anionic surfactants selected from the group consisting of alkylsulfates, secondary alkylsulfonates, secondary alkylbenzenesulfonates and alkylcarboxylates, wherein the surfactant is present in a concentration ratio to water of 1:1 to 1:10, said surfactant dissolved in water.

2. The wetting agent as claimed in claim 1, characterized in that the concentration is 1:2 to 1.6.

3. The wetting agent as claimed in claim 1, characterized in that the nonionic surfactant is a sugar surfactant.

4. The wetting agent as claimed in claim 3, characterized in that the sugar surfactant is selected from the group consisting of alkyl glycosides, alkyl polyglycosides, sorbitan fatty acid esters and polysorbates.

5. The wetting agent as claimed in claim 1 which further comprises a biocide.

6. The wetting agent as claimed in claim 5, characterized in that the biocide is an isothiazolinone.

7. The use of a wetting agent as claimed in claim 1 in electrochemical applications.

8. The use of a wetting agent as claimed in claim 7, characterized in that the wetting agent is used in electrolysis baths.

9. The wetting agent as claimed in claim 1, characterized in that the concentration is 1:2 to 1:4.
